(19) United States
(12) Patent Application Publication
(10) Pub. No.: US 2013/0125031 A1
(43) Pub. Date: May 16, 2013

(54) CONTEXT RELATED LOCATION BASED CONTENT

(71) Applicants: Ben Calica, Seattle, WA (US); Peter Kacandes, San Francisco, CA (US)

(72) Inventors: Ben Calica, Seattle, WA (US); Peter Kacandes, San Francisco, CA (US)

(21) Appl. No.: 11/469,349

(22) Filed: Aug. 31, 2006

(51) Int. Cl. G06F 3/0484

(52) U.S. Cl. CPC G06F 3/0484
USPC 715/764

(57) ABSTRACT

Briefly, in accordance with one embodiment of the invention, location based content may be obtained from a remote network based at least in part on a determined location of a wireless device. The location based content that is obtained is further suitable for a context of an application running on the wireless device. At a suitable time and/or location within the application, the location based content may be rendered in the application within the context of the application without interrupting interaction by the user with the application.

### BACKGROUND

Wireless devices increasingly are including systems capable of determining a location of the wireless devices, for example using the Global Positioning System (GPS). Furthermore, even without specific location determining systems such as GPS, wireless systems inherently may provide at least some level of capability for determining the location of a wireless device. For example, when a cellular telephone is communicating with a cellular network, the identity of the particular base station transceiver on the network may be identified such that it may be determined that the wireless device is located somewhere in the corresponding cell of that particular base station transceiver. Many wireless devices are capable of receiving content via the networks in which they are utilized, thereby increasing the user experience.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, may best be understood by reference to the following detailed description when read with the accompanying drawings in which:

FIG. 1 is a block diagram of a context related location based content delivery system accordance with one or more embodiments;

FIG. 2 is a diagram of display of a wireless device capable of displaying context related location based content in accordance with one or more embodiments;

FIG. 3 is a flow diagram of a method for obtaining and/or delivering context related location based content in accordance with one or more embodiments;

FIG. 4 is a block diagram of a wireless communication system in accordance with one or more embodiments; and

FIG. 5 is a diagram of an information handling system in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

An algorithm and/or process may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the following discussions, it is appreciated that throughout the specification discussion utilizing terms such as processing, computing, calculating, determining, and/or the like, refer to the action and/or processes of a computer and/or computing system, and/or similar electronic computing device, that manipulate or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

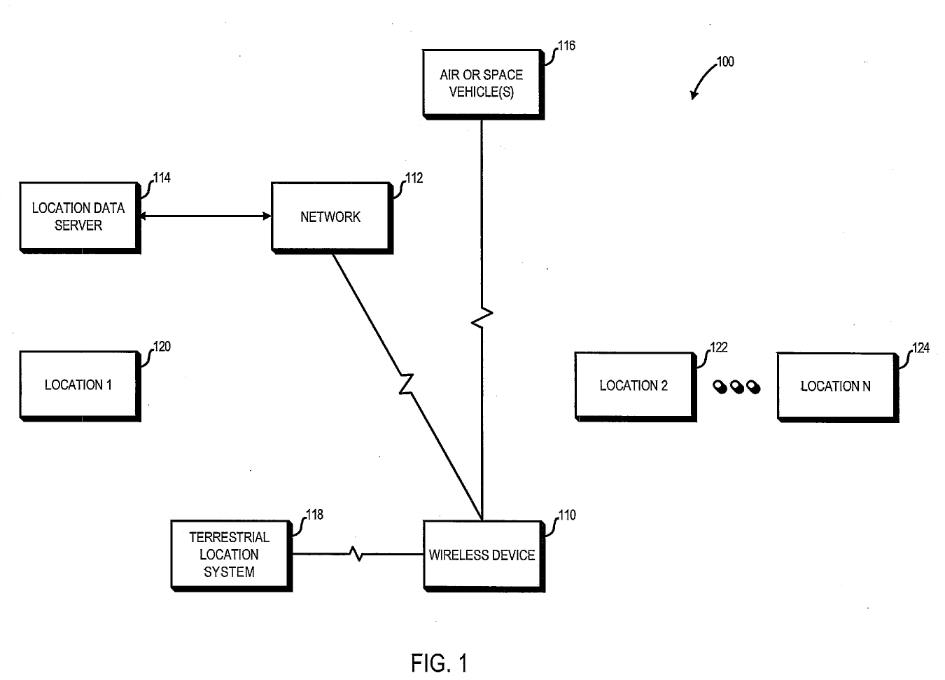

Referring now to FIG. 1, a block diagram of a context related location based content delivery system accordance with one or more embodiments will be discussed. As shown in FIG. 1, location based content delivery system 100 may comprise a wireless device 110 capable of communicating with network 112 via a wireless communication link. Wireless device 110 may comprise, for example, a cellular telephone, a personal data assistant (PDA), a personal computer (PC) such as a laptop computer or a tablet PC, a portable game device having wireless capability, or the like type of device or information handling system. In one or more embodiments, wireless device 110 may run an operating system capable of displaying and/or rendering content on a display of wireless device 110. Network 112 may comprise a cellular telephone network, a wireless local area network (WLAN) type network, a wireless fidelity (Wi-Fi) type network, a Wireless Metropolitan Area Network (WirelessMAN or WiMax) type network, or the like. In one or more embodiments, network 112 may couple to the Internet and/or include the Internet. Furthermore, network 112 may comprise and/or or include a wireless base station and/or access point and may include a base station transceiver or the like capable of communicating with wireless device 110 such that a user of wireless device 110 may communicate with other wireless devices, for example via telephone and/or voice communication. In one or more alternative embodiments, wireless device 110 may be capable of communicating with one or more other devices and/or networks via a packet based type protocol, for example in accordance with General Packet Radio Service (GPRS) and/or Global System for Mobile Communications (GSM) type communication, Evolution-Data Optimized (EV-DO) type communication, Universal Mobile Telecommunications System (UMTS) type communication, Wideband Code Division Multiple Access (W-CDMA) type communication, or the like. The types of networks, network equipment, and/or network protocols discussed herein are merely set forth for purposes of example, and the scope of the claimed subject matter is not limited in these respects.

As a user of wireless device 110 moves about within a geographic region from position to position, the location of wireless device 110 may be determined. In one or more embodiments, a location of wireless device 110 may be determined, for example, by knowledge of the identity of a base station transceiver of network 112 with which wireless device 110 is in communication. As a result, it may be determined which cell in a cellular telephone network that wireless device 110 may be located or is likely to be located and/or adjacent to. In one or more alternative embodiments, the location of wireless device 110 may be determined via communication with one or more space vehicles and/or air vehicles 116 with which wireless device 110 may be in communication. For example, wireless device 110 may receive signals from one or more space vehicles and/or satellites 116 in a constellation of satellites that may allow wireless device 110 to calculate a coordinate position of wireless device 110. Such a location system may comprise, for example, a global positioning system (GPS) type system that may allow wireless device 110 to determine its position from calculations based on one or more time reference signals received from one or more space vehicles 116 that wireless device 110 may receive. In one or more other embodiments, wireless device 110 may determine its location based at least in part on signals that wireless device 110 receives from a terrestrial location system 118. For example, terrestrial location system 118 may comprise a wireless local area network (WLAN) type system including a base station and/or access point capable of communicating with wireless device 110. The location of such a base station and/or access point may be known and broadcast to wireless device 110, for example, such that wireless device 110 may then determine its location and/or approximate location from the location information broadcast by the base station and/or access point. Alternatively, the identity of the base station and/or access point, for example a MAC address, may be broadcast to wireless device 110, and wireless device may determined its location by determining the location of the base station and/or access point, for example by looking up the identity of the base station and/or access point in a lookup table and/or database. In one or more embodiments, terrestrial location system may comprise a wireless ground station, beacon, and or ground based GPS type system such as a system that is part of a differential GPS type system or the like. The location determining systems discussed herein are merely examples of location determining systems, and the scope of the claimed subject matter is not limited in these respects.

In one or more embodiments, the location of wireless device 110 may be determined if wireless device arrives at a location and/or if wireless device 110 travels from one location to another. When the location of wireless device 110 is made, a determination may be made of one or more locations (Location 1) 120, (Location 2) 122, up to Nth location (Location N) 124, that are at and/or proximate to the location of wireless device 110. In one or more embodiments, it may be determined for example that wireless device 110 is located at and/or near location 122 (Location 2). Content may be inserted into an application running on wireless device 110 that may be related to a context of the application and/or the location of wireless device 110. Such insertion of context related location based content may be accomplished as follows. Once the location of wireless device 110 is determined, wireless device 110 may communicate with location data server 114 or the like that may be coupled to wireless device 110 via network 112. Location data server 114 may contain location specific information for one or more of locations 120-124. For example, location 122 may correspond to the location of the Eiffel Tower in Paris, France. When a determination is made that wireless device 110 is disposed in location 122, a lookup may be made in location data server 114 that the Eiffel Tower is located at location 122. Location data server 114 may comprise content corresponding to location 122, such as one or more images and/or videos of the Eiffel Tower. Wireless device 110 may then download the location based content corresponding to location 122, for example an image of the Eiffel Tower. If and/or when appropriate, the image of the Eiffel Tower obtained from location data server 114 may be rendered and/or displayed on a display of wireless device 110. In one or more embodiments, the image of the Eiffel Tower may be displayed and/or rendered when suitable based on the context of the application running on wireless device. For example, the application may be a game type application running on wireless device 110, which may be an airplane flight simulator game. When the user flies an airplane over Paris, France in the application, and if the user is located in location 122 containing the Eiffel Tower, the application may render the image of the Eiffel Tower. The location based data such as the image of the Eiffel Tower may be downloaded from location data server in real time and/or near real time if the context of the application calls for an image of the Eiffel Tower. In one or more alternative embodiments, wireless device 110 may prefetch the image of the Eiffel Tower before it may be suitable to display the image of the Eiffel Tower, and then store the image of the Eiffel Tower in a buffer and/or memory of wireless device 110 until it is suitable to display the image of the Eiffel Tower in the application based at least in part on a context of the application, for example flying an airplane over Paris, France.

In one or more embodiments, a business and/or other entity may elect to provide location based information to be stored in location data server 114, for example for advertising purposes. In one such embodiment, location 122 may be Paris, France, and location data server 114 may store information for the Chez Chong restaurant such as an image of the restaurant and/or advertising type content related to the restaurant such as the restaurant's logo. The Chez Chong restaurant may optionally pay a fee to the operator of location data server 114 and/or the operator of network 112 for such capability. In this example, when wireless device 110 is at location 122 which may be the same location, and/or near or proximate to, the Chez Chong restaurant, and based at least in part on a context of the application running on wireless device 110, wireless device 110 may display information related to Chez Chong in the application. For example, the application may call for displaying a restaurant in the application wherein the application may display an image of the actual Chez Chong restaurant as the image of the restaurant in the application. Alternatively, a billboard advertisement for a restaurant in the application may be rendered with actual information advertising the Chez Chong restaurant such as the restaurant's logo. The location based information displayed by the application on a display of wireless device may thereby be contextually integrated within the application rather than being an interruption that may have nothing to do with the application or a context of the application. The example location based content and/or contextual content are merely examples, and the scope of the claimed subject matter is not limited in this respect.

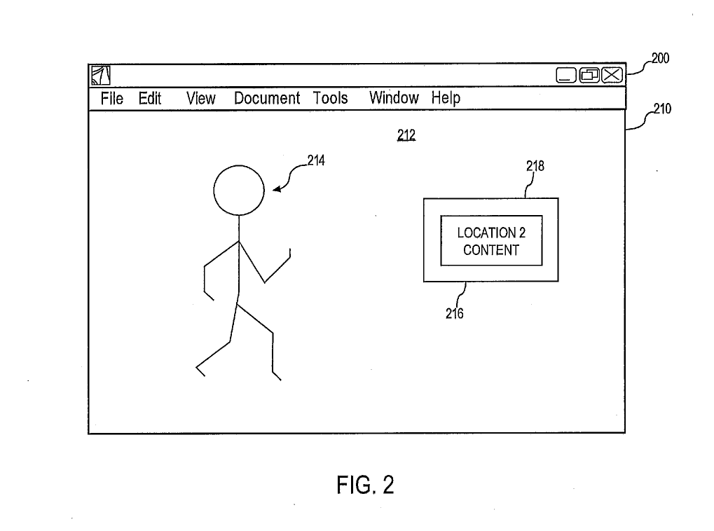

Referring now to FIG. 2, a diagram of display of a wireless device capable of displaying context related location based content in accordance with one or more embodiments will be discussed. As shown in FIG. 2, wireless device 110 of FIG. 1 may render a graphical user interface (GUI) 200 on a display of wireless device. GUI 200 may present an interface for a computer program and/or application 210 running on wireless device 110. In one or more embodiments, application 210 may be an Adboe® Flash® type application, Adobe® FlashCast® type application, Adobe® FlashLite® type application, Adobe® FlashLite SDK® type application, Adobe® Acrobat® type application, available from Adobe Systems Incorporated of San Jose, Calif., USA, or the like type applications. Application 210 may include a display area 212 in which content and/or objects rendered by application 210 may be displayed, for example game content, movie content, and so on. Such content may include, for example, non-location based content and/or objects 214 and/or location based content and/or objects 216. Application 210 may include a region 218 of display area 212 in which location based content 216 may be displayed if available, and/or in which default content may be displayed if location based content 216 is not available. If location based content 216 is available, for example information pertaining to the restaurant Chez Chong as discussed, above, such as location based content 216 pertaining to the restaurant Chez Chong as obtained from location data server 114 via network 112, then such location based content 216 may be rendered if contextually suitable for application 210. For example, if application 210 is a game, and non-location based content 214 is a character, and in the game the character runs past a restaurant which is located within region 218 of display area 212, if wireless device 110 is determined to be located within location 122 where the restaurant Chez Chong is located and/or nearby wireless device 110, then application 210 may render location based content 216 in region 216, for example an image of the Chez Chong restaurant and/or the restaurant's logo, as the character runs past the restaurant in the game. In one or more in embodiments, in this respect, location based content 216 may not only be rendered on a display of wireless device 110, location based content 216 also may be contextually related to the content of application 210. One desired result may be that the user of wireless device 110 may be enticed to patronize the Chez Chong restaurant since the user is currently in the vicinity of the restaurant, although the scope of the claimed subject matter is not limited in this respect. Many other results, applications 210, location based content 218 and/or contexts may similar be implemented, and the scope of the claimed subject matter is not limited in this respect. For example, in one or more alternative embodiments, application 210 may be a mapping program to assist a user of wireless device 110 reach a desired destination. As the user travels from one location to another to reach the desired destination, for example from location 120 to location 120, as passes through location 122 along the way to the desired destination, location based content 216 corresponding to location 122 may be rendered in region 218. For example, if the user passes the Chez Chong restaurant located in location 122 along the way to the desired destination by following a map displayed in display area 212 of the mapping application, location based content 216 relating to the Chez Chong restaurant may be rendered in region 218 in context of the location of the user in the map. If needed, directions for how to get to the Chez Chong restaurant when traveling along the path in the map may be rendered in region 218, a restaurant special such as the lunch special may be rendered in region 218, a menu for the Chez Chong restaurant may be displayed, and so on. Furthermore, region 218 may include hyperlink instructions to allow the user to link to a website corresponding to the Chez Chong restaurant, transportation and/or travel instructions such as where to get on to a Metro train to get to the Chez Chong restaurant, and so on, may be likewise displayed or otherwise available as well. These are examples of contextually related location based content that may be obtained and/or displayed on a display of wireless device 110, and the scope of claimed subject matter is not limited in this respect. In one or more embodiments, at a suitable time and/or location within the application, the location based content may be rendered in the application within the context of the application without interrupting interaction by the user with the application. For example, an image of a restaurant located proximate to the user's current location may be rendered at a location in the display of the application where a restaurant may be suitably displayed without interfering and/or without interrupting the interaction by the user with the application. In the restaurant example, the application may have a character walking down a street past a restaurant. Instead of the application rendering an image of a generic restaurant, the application may render the image of a restaurant located nearby the user's currently determined location. The image of the restaurant may be an actual photographic image of the nearby restaurant, or it may be a graphic representation that resembles the restaurant, for example. Since the application called for displaying a restaurant in any event, then displaying an image of the nearby restaurant instead of a generic image of a restaurant will not interrupt and/or otherwise interfere with the user's operation of and/or interaction with the application. This is one example of how content based location may be rendered without interrupting interaction by the user with the application, and the scope of the claimed subject matter is not limited in this respect.

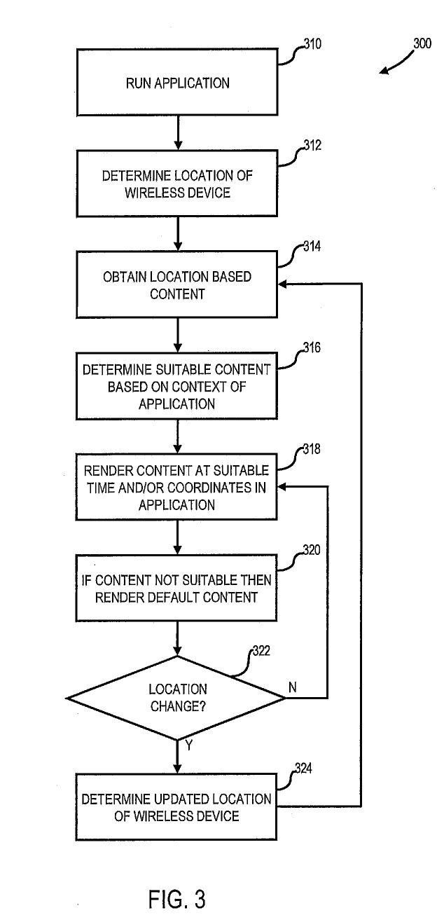

Referring now to FIG. 3, a flow diagram of a method for obtaining and/or delivering context related location based content in accordance with one or more embodiments will be discussed. Method 300 may include the blocks shown in FIG. 3, and/or it may include more or fewer blocks than shown. Furthermore, FIG. 3 shows one order of the blocks of method 300, and other orders may be implemented, and the scope of the claimed subject matter is not limited in these respects. Method 300 may begin if application 210 is run on wireless device 110 at block 310. A location of wireless device 110 may be determined at block 312. Location based content 216 may be obtained at block 314, for example from location data server 114 via network 112. In one or more embodiments, a determination may be made at block 316 which location based content 216 of available location based content may be suitable for a context of application 210 currently being run on wireless device 110. For example, application 210 may be programmed to render location based content 216 that is suitable for a restaurant context. In such an embodiment, location based content 216 that is available for the present location may be searched and/or filtered for restaurant type information. If such suitable content is identified, location based content 216 may be downloaded to wireless device 110, for example at obtaining block 315, in real time or near real time and/or on demand, and/or location based content 216 may be downloaded and stored in a buffer or memory of wireless device 110 to be later retrieved and rendered at block 318 by wireless if called for based on a context of application 210. For example, an event that may result in location based content 216 being called for may occur if the character in the above example walks past a restaurant in the game. Furthermore, such rendering of content at block 318 may be rendered at a suitable time and/or coordinate location within a context of application 210, for example at region 218 if all or part of region 218 is visible in display area 212 of application 210. A determination may be made at block 322 whether the location of wireless device 110 has changed, for example if the user of wireless device has moved from location 122 to location 124. If the location of wireless device 100 has not changed, method 300 may continue to render content at block 218 for suitable times and/or coordinates in application 210 based on location based content 216 corresponding to location 122 for example. If the location of wireless device 100 has changed as determined at block 324, the updated location of wireless device 110 may be determined, for example location 124, then method 300 may continue at block 314 wherein location based content 216 corresponding to the new location, location 124, may be obtained. Method 300 described in FIG. 3 is one example method that may be implemented to render context related location based content 216 by application 210 running on wireless device 110, and the scope of the claimed subject matter is not limited in these respects.

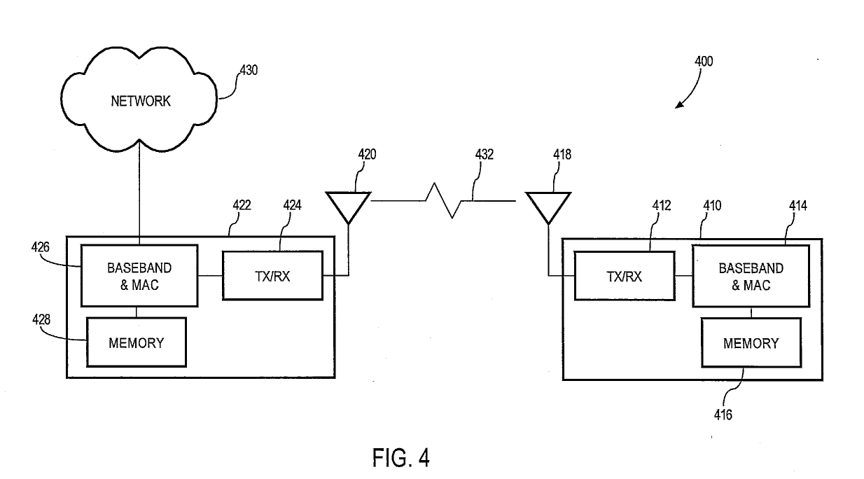

Referring now to FIG. 4, a block diagram of a wireless communication system in accordance with one or more embodiments will be discussed. Wireless communication system 400 may comprise any one or more of the wireless communication systems implemented by wireless device 110 and air or space vehicle(s) 116, network 112, and/or terrestrial location system 118 as shown in FIG. 1, for example. Wireless network 400 may comprise, for example, a wireless local area network (WLAN), a wireless wide area network (WWAN), wireless metropolitan area network (WMAN), wireless personal area network (PAN), and/or a cellular telephone network. In wireless network 400 shown in FIG. 4, client 410 may be for example a mobile or remote unit such as a mobile computer and/or information handling system, a desktop computer, and/or a cellular telephone, for example, and may correspond to wireless device 110 of FIG. 1. Client 410 may include a transceiver 412, and/or a transmitter (TX) and/or a receiver (RX) that may comprise an analog front end and/or radio circuitry to couple to antenna 418. Client 410 may include a processor 414 to provide baseband and/or media access control (MAC) processing functions. In one embodiment, processor 414 may comprise a single processor, and/or alternatively may comprise a baseband processor and/or an applications processor and/or a digital signal processor, although the scope of the claimed subject matter is not limited in this respect. Processor 414 may couple to memory 416 which may include volatile memory such as dynamic random-access memory (DRAM), non-volatile memory such as flash memory, and/or alternatively may include other types of storage such as a hard disk drive or optical disk drive, although the scope of the claimed subject matter is not limited in this respect. Memory 416 or a portion thereof may be included on the same integrated circuit as processor 414, and/or alternatively memory 416 or a portion thereof may be disposed on an integrated circuit and/or other medium, for example a hard disk drive, that is external to the integrated circuit of processor 414, although the scope of the claimed subject matter is not limited in this respect.

Client 410 may communicate with access point 422 via wireless communication link 432, where access point 422 may include at least one antenna 420, transceiver 424, processor 426, and/or memory 428. In an alternative embodiment, access point 422 and/or optionally client 410 may include two or more antennas 418 and/or 420, for example to provide a spatial division multiple access (SDMA) system and/or a multiple input, multiple output (MIMO) system, although the scope of the claimed subject matter is not limited in this respect. Access point 422 may couple with network 430 which may be the same network 112 as shown in FIG. 1, for example, so that client 430 may communicate with network 430, including communicating with devices and/or nodes coupled to network 430, by communicating with access point 422 via wireless communication link 432. Network 430 may include, for example, a public network such as a telephone network and/or the Internet, and/or alternatively network 100 may include a private network such as an intranet, and/or a combination of a public and/or a private network, although the scope of the claimed subject matter is not limited in this respect. Communication between client 410 and/or access point 422 may be implemented via a wireless personal area network (WPAN) standard such as a network in compliance with the WiMedia Alliance, and/or a wireless local area network (WLAN) and/or a wireless wide area network (WWAN), for example a network compliant with an Institute of Electrical and Electronics Engineers (IEEE) standard such as IEEE 802.11a, IEEE 802.11b, IEEE 802.11n, (collectively known as WiFi), IEEE 802.16 (known as WiMax), HiperLAN-II, HiperMAN, Ultra-Wideband (UWB), and so on, although the scope of the claimed subject matter is not limited in this respect. In another embodiment, communication between client 410 and/or access point 422 may be at least partially implemented via a cellular communication network compliant with a Third Generation Partnership Project (3GPP or 3G) standard, a Wideband CDMA (WCDMA) standard, Code Division Multiple access (CDMA), Single Carrier Radio Transmission Technology (1xRTT), Enhanced Data for Global Evolution (EDGE), Evolution Data Only (EV-DO), Fast Low-latency Access with Seamless Handoff Orthogonal Frequency Division Multiplexing (Flash-OFDM), General Packet Radio Service (GPRS), Global System for Mobile Communications (GSM), and/or Universal Mobile Telecommunications System (UMTS), and/or the like, although the scope of the claimed subject matter is not limited in this respect. In one or more embodiments, client 410 may correspond to wireless device 110 of FIG. 1. Likewise, access point 422 may correspond network 112 and/or terrestrial location system 118 of FIG. 1, and so on. Similarly, access point 422 may be a base station transceiver of a cellular telephone network, for example Node B equipment of a UMTS Radio Access Network (RAN) and/or UMTS terrestrial radio access network (UTRAN). However, these are merely examples of a wireless network, and the scope of the claimed subject matter is not limited in this respect.

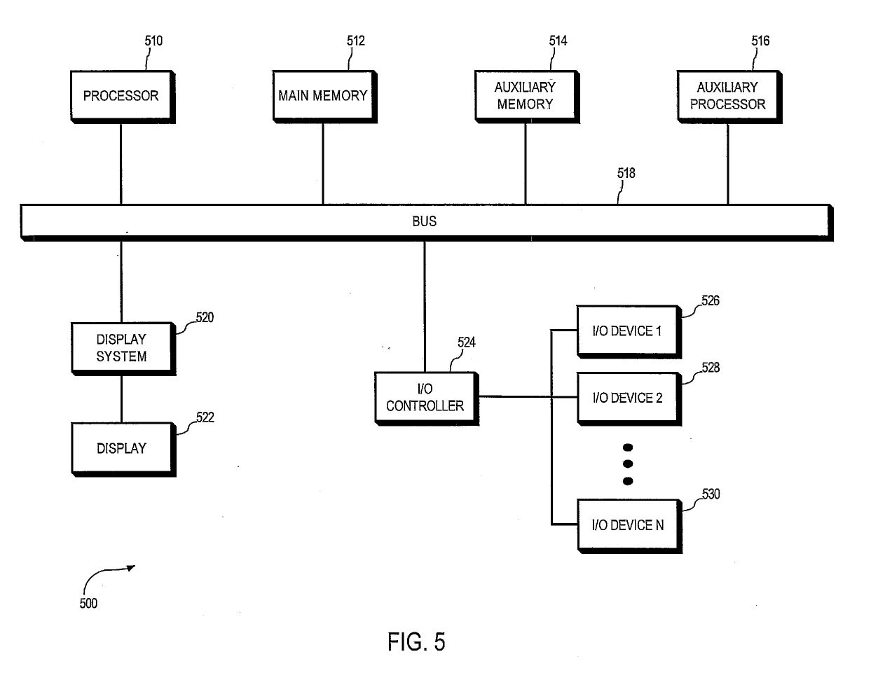

Referring now to FIG. 5, a diagram of an information handling system in accordance with one or more embodiments will be discussed. Information handling system 500 as shown in FIG. 5 may tangibly embody a computing platform on which a software program as discussed with respect to FIG. 2, may be executed to implement GUI 200 and/or in which program 210 may be displayed. Such a computer program and/or machine readable instructions may be tangibly stored on a computer and/or machine readable medium such as a compact disk (CD), digital versatile disk (DVD), flash memory device, hard disk drive (HDD), and so on. Information handling system 500 as shown in FIG. 5 may represent one embodiment of such a computing platform, wherein information handling system may include fewer and/or more blocks to implement various types of computing platforms as desired, and the scope of the claimed subject matter is not limited in this respect.

As shown in FIG. 5, information handling system 500 may be controlled by processor 510. Processor 510 may comprise a central processing unit such as a microprocessor or microcontroller for executing programs, performing data manipulations and controlling the tasks of information handling system 500. Communication with processor 500 may be implemented via bus 518 for transferring information among the components of information handling system 500. Bus 518 may include a data channel for facilitating information transfer between storage and other peripheral components of information handling system 518. Bus 518 further may provide a set of signals utilized for communication with processor 510, including, for example, a data bus, and address bus, and/or a control bus. Bus 518 may comprise any bus architecture according to promulgated standards, for example industry standard architecture (ISA), extended industry standard architecture (EISA), Micro Channel Architecture (MCA), peripheral component interconnect (PCI) type local bus, standards promulgated by the Institute of Electrical and Electronics Engineers (IEEE) including IEEE 488 general-purpose interface bus (GPIB), IEEE 696/S-100, and so on, although the scope of the claimed subject matter is not limited in this respect.

Other components of information handling system may include, for example, main memory 512, and/or auxiliary memory 514. Information handling system 500 may further comprise auxiliary processing processor 516, which may be another processor, a digital signal processor, and so on. Main memory 512 may provide storage of instructions and data for programs to be executed by processor 510. Main memory 512 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Auxiliary memory 512 may be utilized to store instructions and/or data that to be loaded into main memory 512 before execution. Auxiliary memory 514 may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memory 514 may also include any type of non-semiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well. Information handling system 500 optionally include auxiliary processor 516 which may be an auxiliary processor to manage input/output, an auxiliary processor to perform floating point mathematical operations, a digital signal processor and/or any special-purpose microprocessor having an architecture suitable for fast execution of signal processing algorithms, a back-end processor and/or any slave type processor subordinate to processor 510, an additional microprocessor and/or controller for dual and/or multiple processor systems, and/or a coprocessor and/or additional processor. Such auxiliary processors may be discrete processors and/or or may be arranged in the same package as processor 510, for example in a multicore and/or multithreaded processor, however the scope of the claimed subject matter is not limited in these respects.

Information handling system 500 further may include display system 520 for connecting to display 522, and further may include input/output (I/O) controller 524 to connect to one or more I/O devices including, for example, I/O device 626, I/O device 528, up to an Nth I/O device, I/O device 530. Display system 520 may comprise a video display adapter having components for driving display 522, including, for example, video memory, a buffer, and/or a graphics engine. Such video memory may be, for example, video random access memory (VRAM), synchronous graphics random access memory (SGRAM), windows random access memory (WRAM), and/or the like. Display 522 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. Input/output controller 524 may comprise one or more controllers and/or adapters to prove interface functions between one or more of I/O device 526, I/O device 528, and/or I/O device 530. For example, input/output controller 524 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices such as a keyboard, mouse, trackball, touchpad, joystick, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electro-acoustic transducer, microphone, speaker, audio amplifier, and/or the like. Input/output controller 524 and/or I/O device 526, I/O device 528, and/or I/O device 530 may provide and/or receive analog and/or digital signals to communicate between information handling system and external devices, networks, and/or information sources. Input/output controller 524 and/or I/O device 526, I/O device 528, and/or I/O device 530 may implement industry promulgated architecture standards, including, for example, Ethernet IEEE 802 type standards, such as IEEE 802.3 for broadband and/or baseband networks, IEEE 802.3z for Gigabit Ethernet, IEEE 802.4 for token passing bus networks, IEEE 802.5 for token ring networks, IEEE 802.6 for metropolitan area networks and/or the like, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. Information handling system 400 of FIG. 5 is merely one example of an information handling system and/or computing platform, and the scope of the claimed subject matter is not limited in this respect.

Although the claimed subject matter has been described with a certain degree of particularity, it should be recognized that elements thereof may be altered by persons skilled in the art without departing from the spirit and/or scope of the claimed subject matter. It is believed that context related location based content and/or many of its attendant applications will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1. A method comprising:
determining a location of a device that is capable of running a plurality of applications, including a mapping program configured to display a map;
determining a context of the mapping program that is running on the device, wherein the context of the mapping program indicates a particular object encountered or to be encountered at a particular time or display object location within the mapping program during use of the mapping program;
identifying location-based content that is related to the location of the device and is related to the particular object encountered or to be encountered at the particular time or display object location within the mapping program during use of the mapping program, wherein said identifying is based on both the location of the device and the context of the mapping program; and
rendering the identified location-based content within the context of the mapping program, wherein said rendering comprises contextually integrating a display of a textual conveyance of the identified location- based content including information other than an identity of an entity into content displayed on the device by the mapping program such that the identified location-based content is displayed, on the map, relative to a display of the location of the device on the map and while maintaining user interaction with the mapping program .

2. A method as claimed in claim 1, further comprising:
determining another context of the mapping program that is running on the device, wherein the another context of the mapping program indicates another particular object encountered or to be encountered at another particular time or another display object location within the mapping program during use of the mapping program;
determining that no location-based content, which is related to the another particular object encountered or to be encountered at the another particular time or another display object location within the mapping program during use of the mapping program, is available; and
rendering default non-location-based content in the mapping program based on said determining that no related location-based content is available.

3. A method as claimed in claim 1, further comprising:
if the location of the device has changed to a new location, obtaining new location-based content that is related to the new location of the device.

4. A method as claimed in claim 1, further comprising:
if the context of the mapping program has changed to a new context, identifying new location-based content that is contextually related to the new context of the mapping program.

5. (canceled)

6. A method as claimed in claim 1, wherein the device is a wireless device, and said determining a location of the device comprises:
receiving a signal from one or more global positioning system space vehicles; and
calculating a coordinate location of the wireless device based at least in part on the signals received from the one or more global positioning system space vehicles.

7. A method as claimed in claim 1, wherein the context of the mapping program running on the device is suitable for advertising, and the location-based content related to the determined location of the device comprises an advertisement of a business located proximate to the determined location of the device.

8. A method as claimed in claim 1, wherein said obtaining occurs in real-time, or near real-time, if the context of the mapping program calls for the location-based content to be displayed.

9. A method as claimed in claim 1, wherein said obtaining occurs prior to when the context of the mapping program calls for the location-based content to be displayed, and further comprising storing the location-based content at least temporarily on the device, and fetching the stored location-based content if the mapping program calls for the location-based content to be displayed.

10. (canceled)

11. An apparatus comprising:
means for determining a location of a device that is capable of running a plurality of applications, including a mapping program configured to display a map;
means for determining a context of the mapping program running on the device, wherein the context of the mapping program indicates a particular object encountered or to be encountered at a particular time or display object location within the mapping program during use of the mapping program;
means for identifying location-based content that is related to the determined location of the device and to the particular object encountered or to be encountered at the particular time or display object location within the mapping program during use of the mapping program, wherein said identifying is based on both the location of the device and the context of the mapping program; and
means for rendering the identified location-based content within the context of the mapping program, wherein said rendering comprises contextually integrating a display of a textual conveyance of the identified location-based content including information other than an identity of a business into content displayed on the device by the mapping program such that the identified location-based content is displayed, on the map, relative to a display of the location of the device on the map and while maintaining user interaction with the mapping program.

12. An apparatus as claimed in claim 11, further comprising:
means for determining another context of the mapping program that is running on the device, wherein the another context of the mapping program indicates another particular object encountered or to be encountered at another particular time or another display object location within the mapping program during use of the mapping program;
means for determining that no location-based content, which is related to the another particular object encountered or to be encountered at the another particular time or another display object location within the mapping program during use of the mapping program, is available; and
means for rendering default non-location-based content in the mapping program if the location-based content is not contextually related to the context of the application based on said determining that no related location-based content is available.

13. An apparatus as claimed in claim 11, further comprising:
means for obtaining new location-based content related to a new location of the device if the location of the device has changed to the new location.

14. An apparatus as claimed in claim 11, further comprising:
means for identifying new location-based content that is contextually related to a new context of the mapping program if the context of the mapping program has changed to the new context.

15. (canceled)

16. An apparatus as claimed in claim 11, wherein the device comprises a wireless device, and said means for determining a location of the device comprises:
means for receiving a signal from one or more global positioning system space vehicles; and
means for calculating a coordinate location of the wireless device based at least in part on the signals received from the one or more global positioning system space vehicles.

17. An apparatus as claimed in claim 11, wherein the context of the mapping program running on the device is suitable for advertising, and the location-based content comprises an advertisement of a business located proximate to the determined location of the device.

18. An apparatus as claimed in claim 11, wherein said means for obtaining is capable of obtaining the location-based content in real-time, or near real-time, in response to the context of the mapping program calling for the location-based content to be displayed.

19. An apparatus as claimed in claim 11, wherein said means for obtaining is capable of obtaining the location-based content prior to the context of the mapping program calling for the location-based content to be displayed, and further comprising:
means for storing the location-based content at least temporarily on the device; and
means for fetching the stored location-based content in response to the mapping program calling for the location-based content to be displayed.

20. (canceled)

21. An article of manufacture comprising a computer-readable storage medium having instructions executable by a computing platform to:
determine a location of a device that is capable of running a plurality of applications, including a mapping program configured to display a map;
determine a context of the mapping program running on the device, wherein the context of the mapping program indicates a particular object encountered or to be encountered at a particular time or display object location within the mapping program during use of the mapping program;
identify location-based content that is related to the determined location of the device and to the particular object encountered or to be encountered at the particular time or display object location within the mapping program during use of the mapping program, wherein said identifying is based on both the location of the device and the context of the mapping program; and
render the identified location-based content within the context of the mapping program, wherein said rendering comprises contextually integrating a display of a textual conveyance of the identified location-based content including information other than an identity of a business into content displayed on the device by the mapping program such that the identified location-based content is displayed, on the map, relative to a display of the location of the device on the map and while maintaining user interaction with the mapping program.

22. An article of manufacture as claimed in claim 21, wherein said instructions are further executable by said computing platform to:
determine another context of the application that is running on the device, wherein the another context of the mapping program indicates another particular object encountered or to be encountered at another particular time or another display object location within the mapping program during use of the mapping program;
determine that no location-based content, which is related to the another particular object encountered or to be encountered at the another particular time or another display object location within the mapping program during use of the mapping program, is available; and
render default non-location-based content in the mapping program based on said determining that no related location-based content is available.

23. An article of manufacture as claimed in claim 21, wherein said instructions are further executable by said computing platform to, if the location of the device has changed to a new location, obtain new location-based content related to the new location of the device.

24. An article of manufacture as claimed in claim 21, wherein said instructions are further executable by said computing platform to, if the context of the mapping program has changed to a new context, identify new location-based content that is contextually related to the new context of the mapping program.

25. (canceled)

26. An article of manufacture as claimed in claim 21, wherein the device comprises a wireless device, and said determining a location of the device further results in:
receiving a signal from one or more global positioning system space vehicles; and
calculating a coordinate location of the wireless device based at least in part on the signals received from the one or more global positioning system space vehicles.

27. An article of manufacture as claimed in claim 21, wherein the context of the mapping program running on the device is suitable for advertising, and the location-based content comprises an advertisement of a business located proximate to the determined location of the device.

28. An article of manufacture as claimed in claim 21, wherein said obtaining occurs in real-time, or near real-time, if the context of the mapping program calls for the location-based content to be displayed.

29. An article of manufacture as claimed in claim 21, wherein said obtaining occurs prior to when the context of the mapping program calls for the location-based content to be displayed, and further comprising storing the location-based content at least temporarily on the device, and fetching the stored location-based content if the mapping program calls for the location-based content to be displayed.

30. (canceled)
